(19) United States
(12) Patent Application Publication
(10) Pub. No.: US 2013/0043261 A1
(43) Pub. Date: Feb. 21, 2013

(54) CORRUGATED BEVERAGE COASTER/INSULATOR/ADVERTISING SHEATH

(71) Applicant: Eric Barton, Tucson, AZ (US)

(72) Inventor: Eric Barton, Tucson, AZ (US)

(21) Appl. No.: 13/572,686

(22) Filed: Aug. 12, 2012

Related U.S. Application Data
(60) Provisional application No. 61/524,270, filed on Aug. 16, 2011.

(51) Int. Cl. B65D 81/38; B31D 5/00

(52) U.S. Cl. 220/720; 493/297; 493/270

(57) ABSTRACT

An insulating beverage sleeve that can lay flat for use as a coaster is described. The sleeve has two separate corrugated panels held together by a thin, flexible outer sheath. The sleeve can collapse into a platform, where no relatively stiff insulating material undergoes a bend or fold at the edges of the platform.

### CROSS REFERENCE TO RELATED APPLICATIONS

This application claims priority to U.S. Provisional Application No. 61/524,270 the disclosure of which is incorporated herein in its entirety.

### FIELD OF THE INVENTION

The invention relates to insulated sheaths for beverages, and in particular, insulated sheaths made of corrugated paper.

### BACKGROUND OF THE INVENTION

There are a variety of conventional designs for insulated and/or insulating sheaths for beverages. Such sheaths conventionally are constructed of an open-ended cylinder or truncated cone of corrugated paper that is slipped over a beverage cup, e.g., a hot cup of coffee, to reduce heat transfer to or from the cup to or from the holder's hand or fingers. In most conventional designs, the sheath is fabricated from a flat die-cut sheet of corrugated paper, which is folded into some annular shape, i.e., an open-ended cylinder or truncated cone, and secured to itself with an adhesive.

FIGS. 1A and 1B show a conventional insulating beverage sleeve 100. Sleeve 100 is formed of a single piece of single-faced corrugated paper. Sleeve 100 includes a first surface 105. First surface 105 is substantially smooth, and is known in the art as a “linerboard” or a “flat linerboard”. Sleeve 100 also includes a second surface 115. Second surface 115 is includes a plurality of flutes 120 running the length of second face 115. In practice, the corrugated structure of sleeve 100 is formed by impressing a plurality of mutually parallel, single dimensional bends into a first piece of paper, fiberboard or other lightweight material, such that it has a substantially sinusoidal cross-section, and then adhering the fluted material to a second smooth piece of paper, fiberboard or other lightweight material. The resultant assembly has a plurality of hollow tubes or channels defined between the first and second pieces of material.

This structure reduces heat transmission between the second surface 115 and first surface 105 (or vice versa) by providing air spaces within the flutes. As is known in the art, such a structure is useful for insulating a beverage surrounded by sleeve 100, as well as for allowing for safe and comfortable handling of warm beverages. Additionally, the use of a corrugated structure such as sleeve 100 is useful for trapping or absorbing condensation that tends to form on the surface of a cold beverage, thereby providing a more secure grip, e.g., for a cold tapered glass.

The single piece of corrugated paper is secured to itself with a non-illustrated adhesive in the vicinity of an overlap zone 125. The resultant sleeve 100 has the form of a truncated cone with a first open end 112 and a second open end 117. This shape is useful to engage a tapered cup, e.g., a tapered coffee cup. First surface 105 optionally includes a logo 110 or other text.

FIG. 1B shows conventional sleeve 100 in a semi-collapsed configuration. Conventional sleeve 100 includes score lines 130, which are linear through-cuts extending from first surface 105 through second surface 115. Score lines 130 are provided in order to reduce the stiffness of sleeve 100 in the vicinity of fold line 135. This allows for sleeve 100 to be collapsed into a flatter shape, i.e., for shipping and storage, however, the presence of uncut material and corrugated material along fold line 135 creates a spring force that tends to force sleeve 100 open from its collapsed shape. As is set forth below with respect to FIG. 1C, this spring force is aggravated by the crushing of flutes 120 in the vicinity of fold line 135 when conventional sleeve 100 is in its collapsed configuration. It should also be noted that conventional sleeve 100 cannot be flat when collapsed because of overlap region 125.

These shortcomings with conventional beverage sleeves can be seen more clearly in FIG. 1C, which is an end-view of conventional beverage sleeve 100 in the collapsed, nominally “flat” position. As can be seen in FIG. 1C, overlap region 125 prevents conventional sleeve 100 from laying flat. In other words, even in its collapsed state, if first surface 105 of sleeve 100 is placed on a flat surface, the opposite side of sleeve 100 will not be parallel with respect to that surface because of, at least, overlap region 125. This limits the suitability of conventional sleeve 100 for use as a coaster, which requires a uniform, flat surface. Additionally, in its collapsed state, conventional sleeve 100 has two short-radius bend regions 140, which occur in the vicinity of fold lines 135. Bending corrugated paper along a short-radius bend is difficult, as corrugated paper has an inherent stiffness, and will seek to straighten. Moreover, since conventional sleeve 100 is formed of a single piece of corrugated material there are flutes 145 in the vicinity of the short-radius bend or fold 140, which tends to crush or deform said flutes. As a result, flutes 145 elongate and interfere with adjacent flutes. Additionally, flutes 145 seek to return to their natural, undeformed state. The sum of these effects is a spring force in the region indicated that tends for force conventional sleeve 100 into its open position. Additionally, the folding or crushing of stiff insulating material in the vicinity of the short-radius bend or fold 140 has a tendency to create a sheer force between the top and bottom sides of the folded, flattened sleeve. This sheering force tends to prevent the ridges of one side from nesting in the linear depressions defined by the ridges of the opposite side, and instead, causes the ridges to interfere, which prevents conventional sleeves from laying flat.

U.S. Pat. No. 5,259,529 to Coale (“Coale”) discloses a collapsible insulated receptacle for beverage containers. The receptacle of Coale is cylindrical (i.e., to engage a beverage can), and is closed at one end by a “parachute bottom”. The receptacle of Coale appears to be fabricated from two rectangular pieces of paper, mutually coupled to form a piece of corrugated paper, which is joined at a short edge to form a cylinder, without any overlap. In FIG. 5 of Coale, Coale claims that when collapsed the receptacle of Coale results in perfect interlocking engagement between the corrugations of the interior surface of the receptacle, however, there is not sufficient detail to determine how Coale deals with the edges of the structure. As can be seen in more detail in FIG. 6 of Coale, it is clear that folding a continuous cylindrical structure like Coale must necessarily result in crushing of the corrugated flutes that are in the area of the small radius bend, or fold. This tends to provide a spring force that tends to force a collapsed or folded cylinder of corrugated paper into its open position.

U.S. Pat. No. 7,000,801 to Rodriguez (“Rodriguez”) purports to disclose a cylindrical insulating beverage sleeve capable of folding flat to act as a coaster. As is shown in FIG. 8, the sleeve of Rodriquez is formed a single piece of corrugated paper with scored fold lines. Additionally, as is shown in FIG. 4, the beverage sleeve of Rodriquez is not actually capable of folding flat. In the vicinity of A, it can be seen in FIG. 4 of Rodriquez that the corrugated flutes interfere with one another in the vicinity of the small radius fold. Moreover, because the sleeve of Rodriquez is joined by overlapping sections of corrugated paper (i.e., in the vicinity of B and C in FIG. 4), the thickness of the folded flat coaster configuration of the Rodriquez sleeves varies. This tends to create an uneven surface not well suited for use as a coaster.

U.S. Pat. No. 8,025,210 to Johnson et al. (“Johnson”) discloses an insulating beverage holder having large rectilinear flutes with upper and lower apertures for proving air flow. Johnson contains no disclosure regarding how the sleeves of Johnson are fabricated, but the sleeves themselves appear to be fairly complicated. Additionally, there does not appear to be any way for the sleeves of Johnson to fold flat, which would be necessary to use them as a coaster.

U.S. Pat. No. 8,006,861 to Kim (“Kim”) discloses an insulating beverage sleeve having a plurality of embossed and debossed dimples to provide insulation. As in Johnson, it is not clear how the sleeve of Kim could fold flat, and the presence of the uneven surface created by the dimples suggests that the sleeve of Kim would not be suitable for use as a coaster.

### SUMMARY OF THE INVENTION

The invention is directed generally to an improved beverage coaster that is useable as an insulating sleeve. Embodiments according to the invention comprise a plurality of separate pieces of insulating material, e.g., single-face corrugated paper joined together by a highly flexible outer layer, e.g., of paper. The outer layer binds the individual insulating layers together when coaster/sleeves according to embodiments of the invention are used in conjunction with a beverage container in their sleeve-configuration. When coaster/sleeves according to embodiments of the invention are collapsed, the outer layer undergoes a short-radius bend allowing the flutes of the insulating layers to mutually engage. Unlike conventional sleeves fabricated from corrugated paper, when coaster/sleeves according to embodiments of the invention are flattened, there is no stiff corrugated paper material in the vicinity of the short-radius bend or fold. This results in the absence of corrugated paper any crushing or folding of corrugated paper material, which eliminates any spring force that would otherwise tend to force the flattened structure into an open position.

Embodiments according to the invention have certain advantages over conventional beverage insulators. When collapsed into a flat configuration, coaster/sleeves according to embodiments of the invention are held together at the edges by thin material which exerts minimum spring force on the collapsed sleeve. This arrangement creates a stable platform ideal for use as a coaster because it (1) allows the corrugated flutes on opposing panels to mutually engage and interlock without any tension caused by sheer forces and (2) ties the assembly together without spring force at the edges, which would otherwise tend to force assembly into its open position.

Additionally, the use of a thin paper outer sheath, according to embodiments of the invention, allows for labels, advertisements, promotional messages, or other text or graphics to be printed with conventional printing technology that cannot handle printing directly onto corrugated paper. The ability to easily print promotional material on a thin outer layer enables users of embodiments of the invention to implement last-minute changes to beverage coaster/sleeves distributed as promotional material. Additionally, the ability to print onto thin paper coaster/sleeves enables users of embodiments of the invention to do low volume runs of promotional material. Additionally, since the thin, outer coaster/sleeves can be printed at low cost, a promotions company using embodiments of the invention need not bear the risk of printing a specific customer's text directly onto relatively high-cost insulating sleeves. Rather, the only non-recoverable item associated with a specific customer is the thin, paper sleeve material. This results in less waste and lower cost.

Insulating panels according to embodiments of the invention are simple, and can be simply cut to size and assembled.

Other advantages and features of certain embodiments of the invention will become more fully apparent in view of the following description in conjunction with the accompanying figures and claims.

### BRIEF DESCRIPTION OF THE DRAWINGS

FIGS. 1A, 1B and 1C are perspective and side views of a conventional insulating beverage sleeve.

FIG. 2A is a perspective view of a pair of insulating panels for an insulating beverage coaster/sleeve according to an embodiment of the invention.

FIG. 2B is a perspective view of a pair of insulating panels in a cooperative assembly for an insulating beverage sleeve according an embodiment of the invention.

FIG. 3 is a perspective view of a pair of insulating panels joined by an outer sleeve for a insulating beverage sleeve according to an embodiment of the invention, prior to final assembly.

FIG. 4A is a side view of an insulating beverage sleeve according to an embodiment of the invention collapsed into a coaster figuration.

FIG. 4B is a top view of the insulating beverage sleeve of FIG. 4A expanded into its sleeve configuration.

FIG. 5 is a top view of an arrangement of outer sheaths in preparation for printing according to one embodiment of the invention.

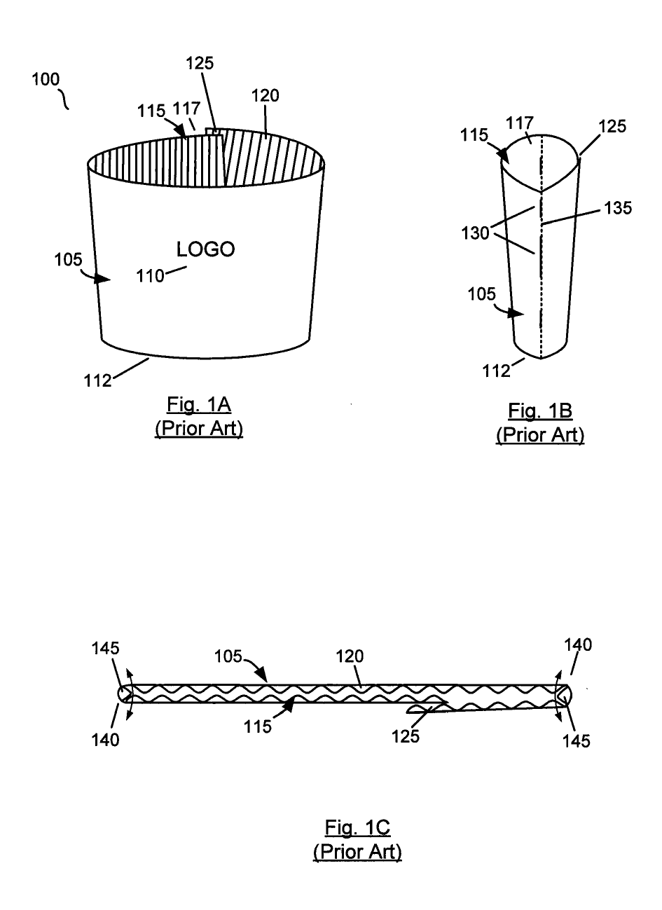

### DETAILED DESCRIPTION OF THE PREFERRED EMBODIMENTS

Apparatuses are described below that advantageously function as both a beverage coaster and an insulating beverage sleeve. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention as defined by the appended claims.

Moreover, in the following description, numerous specific details are set forth to provide a thorough understanding of the present invention. However, it will be apparent to one of ordinary skill in the art that the invention may be practiced without these particular details. Other, methods, materials and structures that are well-known to those of ordinary skill in the art are not described in detail to avoid obscuring aspects of the present invention.

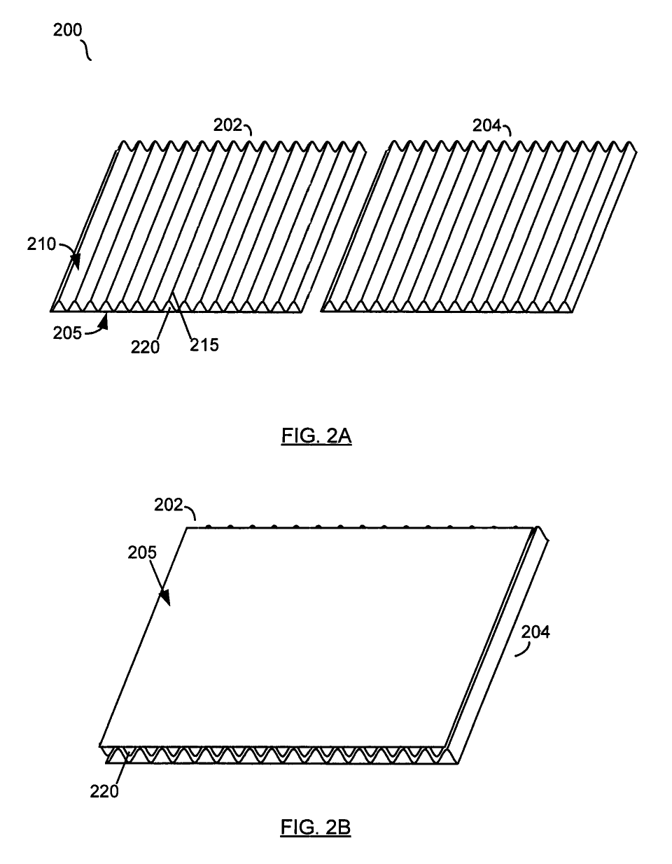

FIG. 2A shows a pair of insulating panels for an insulating beverage sleeve according to an embodiment 200 of the invention. The embodiment of FIG. 2 includes a first insulating panel 202 and a second insulating panel 204. Each insulating panel is constructed of single face, corrugated paper. (As used herein corrugated paper is meant to describe corrugated cardboard, paper, or fiberboard or other similarly flexible material capable of facilitating the intent of the invention described herein). Other corrugated, or otherwise insulating materials are acceptable for use in conjunction with the instant invention and should be considered within the scope of the instant invention.) Each insulating panel of the embodiment 200 of FIG. 2 is assembled or manufactured from two sheets of material: a smooth sheet, and a corrugated or fluted sheet that is adhered to the smooth sheet. The resulting assembly includes a smooth face 205 and a corrugated face 210. Corrugated face 210 is characterized by a plurality of mutually parallel ridges 215 or flutes that define corresponding channels 220. In one embodiment panels 202, 204 are approximately 3 mm thick. In the embodiment of FIG. 2A, panels 202, 204 are fabricated from B flute corrugated fiber board and are rectangular, measuring approximately 4 inches on a side.

When placed in proximity to a hot or cold surface, corrugated materials exhibit a resistance to thermal transfer due to (1) creating relatively long conduction paths through the structure of the corrugated material, where each conduction path has a relatively narrow cross section and (2) creating dead air spaces (i.e., channels 220), which limit convection. Additionally, it is believed that when corrugated material is placed in proximity to a warm surface, air within channels 220 (assuming they are vertically oriented) will warm and tend to rise, thereby drawing cool air into the channels from the bottom. It is further believed, that when corrugated material is placed in proximity to a cold surface, any condensation produced by that surface could be absorbed by the corrugated material and through evaporation cause a cooling effect thus increasing the insulating value of the corrugated material. In operation, insulating panels 202, 204 are placed with their corrugated surface 210 toward the beverage to be insulated, and the smooth side 205 faces toward and is engaged by the holder of the beverage.

FIG. 2B shows an assembly of panels 202, 204 mutually engaged for easy storage and transport, or to be used as a coaster. As can be seen, panel 202 faces and is in contact with panel 204, and the flutes 215 of panel 202 engage with and nest into the troughs or low regions defined by flutes on opposite panel 204. This locks panel 202 in place with respect to panel 204 and forms a stable, crush resistant platform or base capable of supporting a beverage and protecting a surface on which the assembly of FIG. 2B is placed, for example, from condensation. Additionally, outwardly facing smooth side 205 of panel 202 is held to be parallel to the outwardly facing smooth side of panel 204, which means that smooth side 205 is parallel to a surface on which panel 204 is placed. In an embodiment of the invention, the platform formed from panel 202 and 204 is tied together with a highly flexible outer membrane or sheath that wraps around panels 202, 204 without exerting significant force on panels 202, 204 when the assembly is in its collapsed state. This is accomplished by providing two physically separate panels, according to FIG. 2B, which form a platform, and which are not connected with stiff material along the edges of the platform, but instead, are connected with a thin, flexible outer sheath along the edges. The assembly of FIG. 2B overcomes the disadvantages of prior art beverage sleeves by providing a sleeve that can be collapsed into stable, plane-parallel surface to use as a beverage coaster, without any mechanical tension, sheering forces, or surface variations that would tend to create an uneven surface.

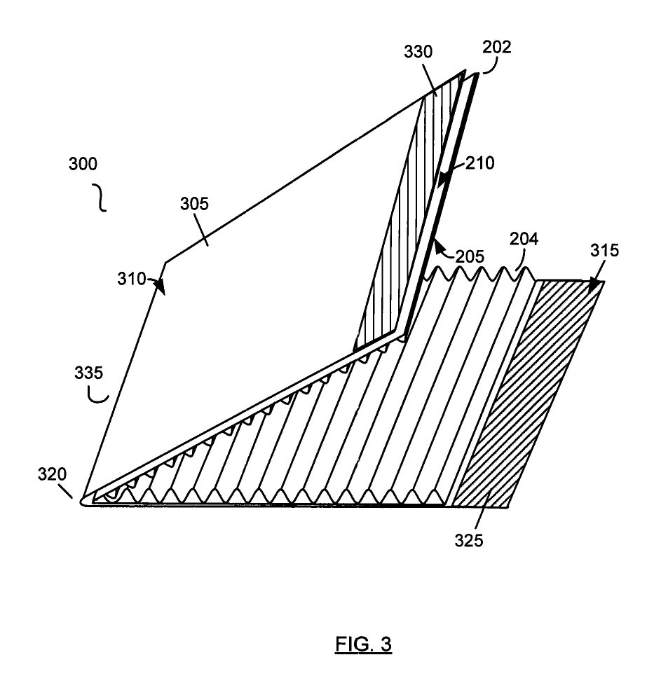

FIG. 3 shows a partially disassembled insulating beverage sleeve and coaster 300 according to an embodiment of the invention. The embodiment of FIG. 3 includes a first and a second insulating panel 202, 204, each panel being fabricated from single-face corrugated paper, and as a result, each panel having a corrugated face 205, and a smooth face, 210. The sleeve 300 also includes an outer sheath 305. In one embodiment, Outer sheath 305 is preferably paper, for example, white paper having a thickness of approximately 0.1 mm and capable of being marked by use of conventional printing processes. Sheath 305 is rectangular in shape, in one embodiment measuring approximately 4×8.5″. Sheath 305 includes an outer surface 310 and an inner surface 315. Inner surface 315 is adhered to the smooth faces (e.g., 210) of the first and second insulating panels 202, 204 by any acceptable conventional adhesive such that sheath 305 covers the smooth faces of the first and second insulating panels, as shown. Sheath 305 includes an extended area or tab 325 sized to be folded over such that the inner surface 315 of sheath 305 overlaps and engages with its outer surface 310. Tab 325 preferably has an adhesive disposed thereon, which adheres tab 325 to an overlap area 330 located on an outer surface 310 of sheath 305.

Outer sheath 305 serves to couple together first panel 202 and second panel 204, such that the entire assembly can be expanded to form a substantially cylindrical insulating beverage sleeve. When the sleeve is collapsed, outer sheath 305 acts as a pair of hinges allowing the first and second panels 202, 204 to cooperatively engage in the manner depicted in FIG. 2B. In the collapsed configuration, outer sheath 305 undergoes a small or short radius bend 320 at the edge of the assembly. In one embodiment, the radius of short radius bend 320 is approximately 1.6 mm, or half the approximate total thickness of the coaster configuration given by the combined thicknesses of the insulating panels in contact with one another along their corrugated faces (approximately 3 mm) plus twice the thickness of outer sheath 305 (where the outer sheath is approximately 0.1 mm thick). Because outer sheath 305 is fabricated preferably from thin paper, there is dramatically less spring force associated with small radius bend 320 than there would be if there was corrugated paper in the vicinity of this region. Indeed, it has been observed that much shorter radius bends, approaching zero (i.e. a crease or fold), in the outer sheath are acceptable and do not result in significant spring force being exerted on the insulating panels. Short radius bends of smaller than 0.1 mm have been tested and are acceptable, as are of course, larger radius bends (e.g., up to 5 mm). By providing a coaster/insulating sleeve as two separate pieces of corrugated paper, neither of which experiences any short radius bending or crushing, a flat, plane-parallel, stable assembly can be achieved, ideally suited for use as a coaster or for easy transport and storage.

In the embodiment of FIG. 3 tab 325, which is an extended portion of the inner surface 315 of sheath 305 is adhered to the outer surface 310 of sheath 305 in the vicinity of overlap area 330, but this is not a requirement. For example, instead of wrapping around the outside of sheath 305, tab may be tucked and adhered below sheath 305 in the vicinity of overlap area 330, such that it is disposed between an inner surface 315 of sheath 305 and a smooth surface 210 of first panel 202. Such an arrangement may require adhesive on both sides of tab 315. Such an arrangement would be advantageous since it would result in a mechanically stronger package less prone to peeling. Moreover, in the embodiment of FIG. 3, tab 325 is relatively short, measuring approximately 0.5″, however, this is not a requirement. In certain embodiments, tab or extended area is significantly longer, and in fact, can extend all the way across and around the top side of the assembly 300 to adhere to outer surface 310 of sheath 305 in the vicinity pointed to by reference indicator 335.

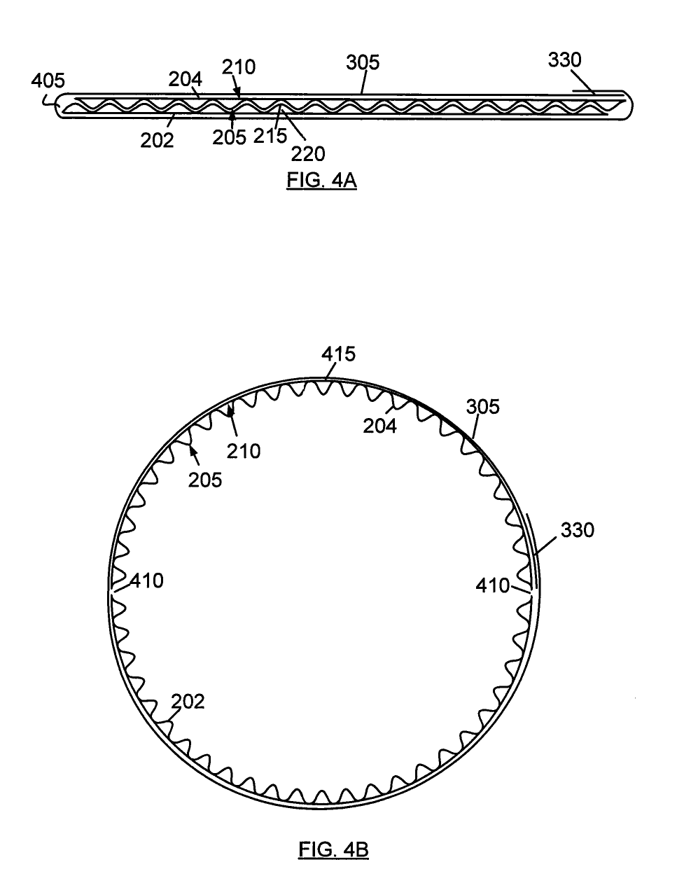

FIG. 4A is a side view of a collapsed insulating beverage sleeve and coaster according to an embodiment of the invention. In the embodiment of FIG. 4, the sleeve according to the invention has been collapsed or folded into its flat configuration for use as a beverage coaster, or for storage and transport. The sleeve of FIG. 4, as in the embodiments set forth above, comprises a first and a second insulating panel 202, 204, each fabricated from single face corrugated paper. Each insulating panel 202, 204 has a smooth face 210 and a corrugated face 205. Corrugated face 205 is characterized by a plurality of mutually parallel ridges 215 or flutes that define corresponding channels 220. Insulating panels 202, 204 are arranged in contact with one another such that their respective corrugated faces are mutually engaged with the ridges or flutes 215 of a first panel laying in the linear depressions defined by adjacent ridges or flutes in a second panel. Such an arrangement provides a stable and inter-locking structure that prevents relative motion between the first and second panel 202, 204 along all axes of translation or rotation except translation along the direction of the ridges or flutes.

The sleeve of FIG. 4A includes an outer sheath 305 which is adhered to the smooth faces of both insulating panels 202, 204, and wraps around insulating panels to form a unitary structure. Outer sheath 305 is adhered to itself in the vicinity of overlap area 330. At the edges of the sleeve of FIG. 4, outer sheath 305 undergoes a short radius bend 405. Because outer sheath 305 is fabricated preferably from thin paper, there is dramatically less spring force associated with short radius bend 405 than there would be if there was corrugated paper in the vicinity of this region. By providing a coaster/insulating sleeve as two separate pieces of corrugated paper, neither of which experiences any short radius bending or crushing, a flat, plane-parallel, stable assembly can be achieved, ideally suited for use as a coaster or for easy transport and storage.

FIG. 4B shows a top view of the sleeve of FIG. 4B expanded into its sleeve configuration. In its expanded, open or sleeve configuration, the sleeve of FIG. 4B has a substantially annular cross section and defines an open ended cylindrical space to surround and engage a beverage container. As in the configuration of FIG. 4A, the sleeve configuration of FIG. 4B has a first and a second insulating panel 202, 204, each insulating panel being fabricated from single face corrugated paper, and each insulating panel having a smooth face 210 and a corrugated face 205. Insulating panels 202, 204 are mutually coupled by a surrounding outer sleeve 305, preferably made of relatively thin paper. Outer sheath 305 is adhered to and wraps around both insulating panels 202, 204 and is adhered to itself at overlap area 330. Between outer sheath 305 and the smooth faces 210 of panels 202, 204, is a gap 415 in which adhesive is disposed, although adhesive need not be disposed throughout the entirety of gap 415. Mutually facing edges of panels 202, 204 define gaps 410 between panels 202, 204. Gaps 410 are bridged by outer sleeve 305, and are instrumental in allowing panels 202, 204 to mutually engage with minimum tension when the sleeve of FIGS. 4A and 4B is collapsed flat. In one embodiment, the linear extent of gap 415 (i.e., the distance between panels 202, 204 when the sleeve of FIGS. 4A and 4B is disassembled at the overlap area 330 and laid flat is approximately 3.5 mm. In operation, outer sheath 305 prevents expansion of a cylinder defined by panels 202, 204 such that panels 202, 204 are kept in close contact with a substantially cylindrical portion of a beverage container (e.g., a beverage can, or the wide, cylindrical portion of a bottle).

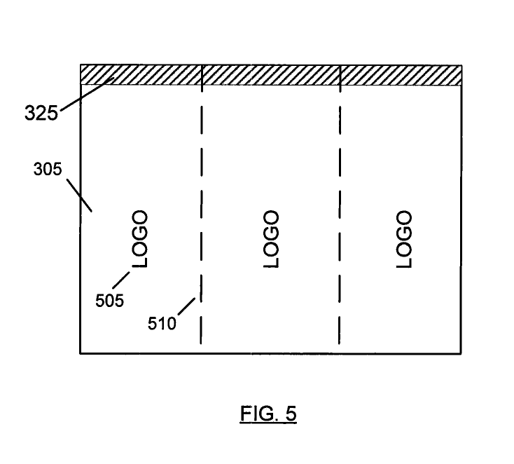

FIG. 5 shows an arrangement of outer sheaths 305 laid out on a standard 8.5×11″ sheet of paper. Given the approximate 8.5×4″ dimension of an outer sheath according to an embodiment of the invention, three sheaths can be fabricated from a single 8.5×11″ piece of paper. Optionally, each sheath 305 can be printed with information, for example, text or graphics such as a logo 505, nutritional information, advertisements or promotional information or the like. After printing, individual sheaths 305 are separated from one another along fold or cut lines 510, in preparation for assembly into beverage coaster/sleeves. As can be seen from FIG. 5, embodiments of the invention allow for rapid and inexpensive customization of insulating sleeve labels by allowing labels to be printed separately from the corrugated paper insulation on any conventional printing device capable of printing on standard paper.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is to be understood that the terminology used herein is for the purpose of describing particular embodiments only, and is not intended to be limiting, since the scope of the present invention will be limited only by the appended claims.

What is claimed is:

1. An insulating beverage coaster/sleeve having an open configuration suitable for engaging a beverage container and a collapsed configuration, the coaster/sleeve comprising;
a first insulating panel having a smooth surface and a corrugated surface, the corrugated surface having a plurality of linear, mutually parallel flutes;
a second insulating panel having a smooth surface and a corrugated surface, the corrugated surface having a plurality of linear, mutually parallel flutes;
an outer sheath of a thinner and more flexible material than the first and second insulating panels, attached to the smooth surfaces of the first and second insulating panels and attached to itself; wherein, in the sleeve's open configuration, the outer sheath has an annular shape and prevents outward deflection of the first and second insulating panels such that the outer sheath and the first and second insulating panels define an open ended, cylindrical space; and wherein, in the sleeve's collapsed configuration, the corrugated surface of the first panel is opposite to and in contact with the corrugated surface of the second panel such that the flutes of the first panel lay in depressions defined by adjacent flutes in the second panel, such that together the first and the second panels form a platform having a plurality of edges and two flat, substantially mutually parallel, outwardly facing smooth surfaces; and the outer sheath wraps around and undergoes a short radius bend at at least one edge of the platform and joins the first and second panels together at the at least one edge of the platform such that the first and second panels are joined without being folded or deformed.

2. The sleeve of claim 1, wherein the outer sheath wraps around and undergoes a short radius bend at a second edge of the platform and joins the first and second panels together at the second edge of the platform such that the first and second panels are joined without being folded or deformed.

3. The sleeve of claim 1, wherein short radius bend means a bend in the range of 0.1 to 5 mm.

4. The sleeve of claim 1, wherein short radius bend means a bend of approximately 1.6 mm.

5. The sleeve of claim 1, wherein outer sheath comprises a sheet of paper.

6. The sleeve of claim 5, wherein the thickness of outer sheath is approximately 0.1 mm and the thickness of the platform is approximately 3 mm.

7. The sleeve of claim 1, wherein each insulating panel is substantially rectangular measuring approximately 4 inches×4 inches.

8. The sleeve of claim 1, wherein the outer sheath is substantially rectangular measuring approximately 4×8.5″

9. The sleeve of claim 1, wherein each insulating panel is substantially trapezoidal and said outer sheath is substantially trapezoidal.

10. The sleeve of claim 1, wherein the outer sheath has text or graphical information printed thereon.

11. An insulating beverage sleeve having an open configuration suitable for engaging a beverage container and a collapsed configuration, the sleeve comprising;
a first insulating panel
a second insulating panel;
an outer sheath of a more flexible material than the first and second insulating panels, attached to the first and second insulating panels and attached to itself;
wherein, in the sleeve's open configuration, the outer sheath has an annular shape and prevents outward deflection of the first and second insulating panels such that the outer sheath and the first and second insulating panels define an open ended, cylindrical space; and wherein, in the sleeve's closed configuration;
the first and second insulating panels are in mutual contact such that together the first and the second panels form a platform having a plurality of edges and two flat, substantially mutually parallel, outwardly facing smooth surfaces; and
the outer sheath wraps around and undergoes a short radius bend at at least one edge of the platform and joins the first and second panels together at at least one edge of the platform such that the first and second panels are joined without being folded or deformed.

12. A method of fabricating an insulating beverage sleeve having an open configuration suitable for engaging a beverage container and a collapsed configuration, the method comprising;
providing a first insulating panel having a smooth surface and a corrugated surface, the corrugated surface having a plurality of linear, mutually parallel flutes;
providing a second insulating panel having a smooth surface and a corrugated surface, the corrugated surface having a plurality of linear, mutually parallel flutes;
providing an outer sheath of a thinner and more flexible material than the first and second insulating panels, wherein said outer sheath is of an extent long enough to cover the first and second insulating panels when said first and second insulating are positioned side by side, as well as to have an excess extent as a tab;
attaching said outer sheath to the smooth surfaces of the first and second insulating panels such the insulating panels are arranged side-by-side with a gap separating an edge of each insulating panel;
bending said outer sheath into an annular shape such that it has an outwardly facing surface and such that it bridges the gap between the insulating panels;
fastening the tab to a surface of the outer sheath.

13. The method of claim 12, wherein the tab is fastened to the outwardly facing surface of the sheath.

14. The method of claim 12, wherein said first and second insulating panels each have a corrugated surface opposite their respective smooth surfaces, each corrugated surface having a plurality of linear, mutually parallel flutes.

15. The method of claim 14, wherein said outer sheath, the positioning of the first and second insulating panels, and the size of the gap permit the sleeve to assume a collapsed configuration wherein;
the corrugated surface of the first panel is opposite to and in contact with the corrugated surface of the second panel such that the flutes of the first panel lay in depressions defined by adjacent flutes in the second panel, such that together the first and the second panels form a platform having a plurality of edges and two flat, substantially mutually parallel, outwardly facing smooth surfaces; and
the outer sheath wraps around and undergoes a short radius bend at at least one edge of the platform and joins the first and second panels together at the at least one edge of the platform such that the first and second panels are joined without being folded or deformed.

16. The method of claim 15, wherein said sleeve is capable of assuming an open configuration wherein the outer sheath and the first and second insulating panels define an open ended, cylindrical space, and wherein the corrugated surfaces of the first and second insulating panels face toward the interior of the cylindrical space.

17. The method of claim 12, further comprising printing text or graphical information on the outwardly facing surface of the outer sheath.

18. The method of claim 18, further comprising providing multiple outer sheaths on a single piece of paper capable of having text or graphical information printed thereon.
